(19) United States
(12) Patent Application Publication
(10) Pub. No.: US 2012/0019999 A1
(43) Pub. Date: Jan. 26, 2012

(54) TOUCHPAD

(75) Inventor: Chen Yao Shao, Beijing (CN)

(73) Assignee: NOKIA CORPORATION, Espoo (FI)

(21) Appl. No.: 13/001,620

(22) PCT Filed: Jun. 27, 2008
(86) PCT No.: PCT/EP08/05300

§ 371 Date: Oct. 13, 2011

(51) Int. Cl. G06F 3/033; G06F 1/16; H01H 13/00

(52) U.S. Cl. 361/679.3; 200/329

(57) ABSTRACT

A touchpad with two or more concentrically arranged curved touch sensitive areas. The curved touch sensitive areas are distinguished from one another by level variations and may from a rippled or undulating surface that allow a user to identify the individual curved touch sensitive areas blindly.

### FIELD OF THE INVENTION

The present invention relates to a touchpad for user input in electronic devices, in particular to touchpads with touch sensitive areas that have a curved shape, and more particularly to a mobile electronic device having such a touchpad.

### BACKGROUND OF THE INVENTION

WO 2008/025370 discloses a portable/mobile media player having a touchpad with concentric rings. The input from the touchpad in the form of a fingertip being moved over the touchpad is e.g. used for controlling a scrolling function. In this device a swirling is transformed into a linear scrolling movement. Alternatively a radial or tangential finger movement is transformed into a linear scrolling movement. The progressiveness of the relation between the angular position and the one-dimensional signal is a function of the radial position. The touchpad has two discrete curved sections with different input sensitivity. The touchpad is also provided with a central select key.

An advantage of the swirling based finger movement control is that a user is able to easily and rapidly transverse a lengthy list of media items in a scrolling function.

However, there is a desire to further improve the user friendliness and comfort of touch input devices as well as a need for further improved feedback to the user.

### DISCLOSURE OF THE INVENTION

On this background, it is an object of the present invention to provide a touchpad with improved feedback to the user. This object is achieved by providing an electronic device comprising an input device including an operating face with two or more concentrically arranged curved touch sensitive areas, wherein the curved touch sensitive areas are distinguished from one another and from the operating face by level variations.

By providing curved touch sensitive areas that have are differentiated by level variations relative to neighboring touch sensitive areas or relative to the operating face, a user can easily feel wherein the curved touch sensitive areas are located, and thereby the user can operate the device blind, e.g. without looking.

The curved touch sensitive areas and/or their borders can be raised and/or lowered relative to the operating face and/or relative to neighboring curved touch sensitive areas.

The neighboring curved touch sensitive areas may form a rippled or undulating surface.

One of the concentrically arranged touch sensitive areas can be a central oval or circular touch sensitive area.

The curved touch sensitive areas may form a series of peaks and/or troughs.

The curved touch sensitive areas may have the shape of closed curves. The closed curves can be ovals or circles.

The electronic device can be a hand portable device.

The electronic device may comprise a mobile phone and/or a media player and/or a digital still or motion camera and/or a navigation device.

Preferably, the curved touch sensitive areas can be felt by a user.

The curved touch sensitive areas can be configured so that the user can identify the curved touch sensitive area on the operating device without looking.

Preferably, at least one of the curved touch sensitive areas is used for navigational input.

The central oval or circular touch sensitive area can be used for selection input.

Preferably, a finger movement over a curved touch sensitive area is translated into a linear input for the electronic device.

The finger movement may control a scrolling function.

The curved touch sensitive areas can be distinct by level differentiation between the respective surfaces of the at two or more curved touch sensitive areas.

It is another object of the invention to provide a touchpad comprising two or more concentrically arranged curved touch sensitive areas, wherein the curved touch sensitive areas are distinguished from one another by level variations.

It is another object of the invention to provide an electronic apparatus comprising an operating face with a display and a touchpad comprising two or more concentrically arranged curved touch sensitive areas, wherein the curved touch sensitive areas are distinguished from one another by level variations and the display and the touchpad are substantially flush with the operating face.

This arrangement is advantageous in that the single surface provides a seamless touch area in that a user may user the concentric ring user interface and then slide/swipe their finger to the display/touchpad area hence providing one continuous user interface area.

The display may be touch sensitive.

The operating face including the display and the touchpad is preferably substantially seamless.

Further objects, features, advantages and properties of the electronic device and the touchpad, according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which:

FIG. 1 is a plane front view of a mobile phone with a touchpad according to a first embodiment of the invention,

FIG. 1A is a cross-sectional view through the mobile phone of FIG. 1 along the line A-A,

FIG. 2 is a block diagram illustrating the general architecture of a mobile phone of FIG. 1 in accordance with the present invention,

FIG. 3 is a plane front view of a mobile phone with a touchpad according to a second embodiment of the invention,

FIG. 3A is a cross-sectional view through the mobile phone of FIG. 3 along the line A-A′,

FIG. 4 is a plane front view of a mobile phone with a touchpad according to a third embodiment of the invention,

FIG. 4A is a cross-sectional view through the mobile phone of FIG. 4 along the line A-A′,

FIG. 5 is a plane front view of a mobile phone with a touchpad according to a fourth embodiment of the invention,

FIG. 5A is a cross-sectional view through the mobile phone of FIG. 5 along the line A-A′, and

FIG. 6 is an elevated view of the mobile phone shown in FIG. 5.

### DETAILED DESCRIPTION OF PREFERRED EMBODIMENTS

In the following detailed description, the touchpad and the mobile electronic device, according to the invention in the form of a cellular/mobile phone will be described by the preferred embodiments.

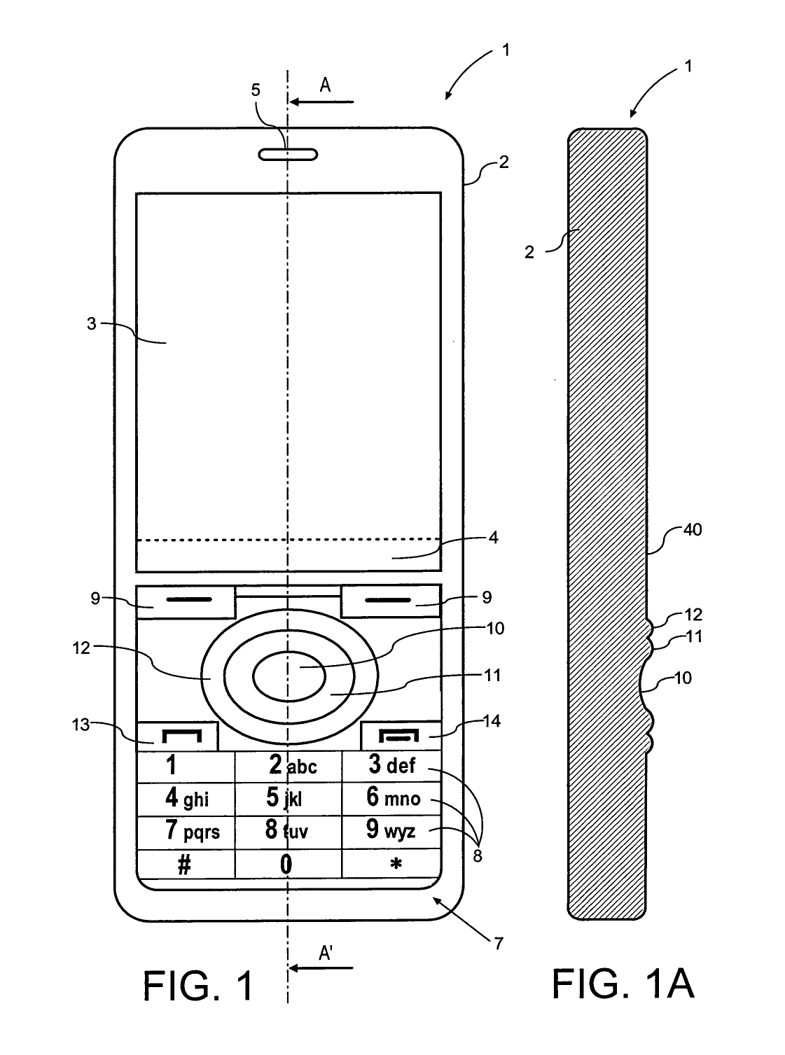

FIG. 1 illustrates a first embodiment of a mobile terminal according to the invention in the form of a mobile telephone 1 by a front view. The mobile phone 1 comprises a user interface having a housing 2, a display 3, an on/off button (not shown), a speaker 5 (only the opening is shown), and a microphone 6 (not visible in FIG. 1). The phone 1 according to the first preferred embodiment is adapted for communication via a cellular network, such as the GSM 900/1800 MHz network, but could just as well be adapted for use with a Code Division Multiple Access (CDMA) network, a 3G network, or a TCP/IP-based network to cover a possible VoIP-network (e.g. via WLAN, WIMAX or similar) or a mix of VoIP and Cellular such as UMA (Universal Mobile Access).

The keypad 7 has a first group of keys 8 as alphanumeric keys, by means of which the user can enter a telephone number, write a text message (SMS), write a name (associated with the phone number), etc. Each of the twelve alphanumeric keys 8 is provided with a figure “0-9” or a sign “#” or “*”, respectively. In alpha mode each key is associated with a number of letters and special signs used in the text editing.

The keypad 2 has additionally a second group of keys comprising two softkeys 9, two call handling keys (offhook key 13 and onhook key 14), a touchpad with an inner area formed by an inner touch ring 11 for e.g. scrolling fast, and an outer area formed by an outer touch ring 12 for e.g. scrolling slow and precise, as well as a select/activate touch area 10. The constructional details of the touchpad will described further below. The function of the softkeys 9 depends on the state of the phone, and navigation in the menu is performed by using the touch ring 11 and/or outer touch ring 12 of the touchpad. The present function of the softkeys 9 is shown in separate fields (soft labels) in a dedicated area 4 of the display 3, just above the softkeys 9. The two call handling keys 13,14 are used for establishing a call or a conference call, terminating a call or rejecting an incoming call. This key layout is characteristic for e.g. the Nokia 6230i™ phone.

As seen in the cross-sectional view of FIG. 1A that is taken along the line A-A′ FIG. 1, the central oval touch area 10 is distinguished/differentiated from the neighboring touch ring 11 by variation in the level of the oval touch area 10. Similarly, the inner touch ring is distinguished or differentiated from the outer touch ring 12 by variation in the level of the outer touch ring 12. The outer touch ring 12 is also differentiated from the operating face 40 by a level change. It is noted that the cross-sectional has been simplified for illustrative purposes and does not show the inner components of the device 1.

The central oval touch area 10 has a concave (curving inward) level change. Inner touch ring 11 has a convex (curving outward) level change and the out of touch ring 12 also has a convex level change. This arrangement of level changes allows a user to identify the inner central oval touch area 10, and the inner touch ring 11 and the outer of touch ring 12 blindly, e.g. without looking.

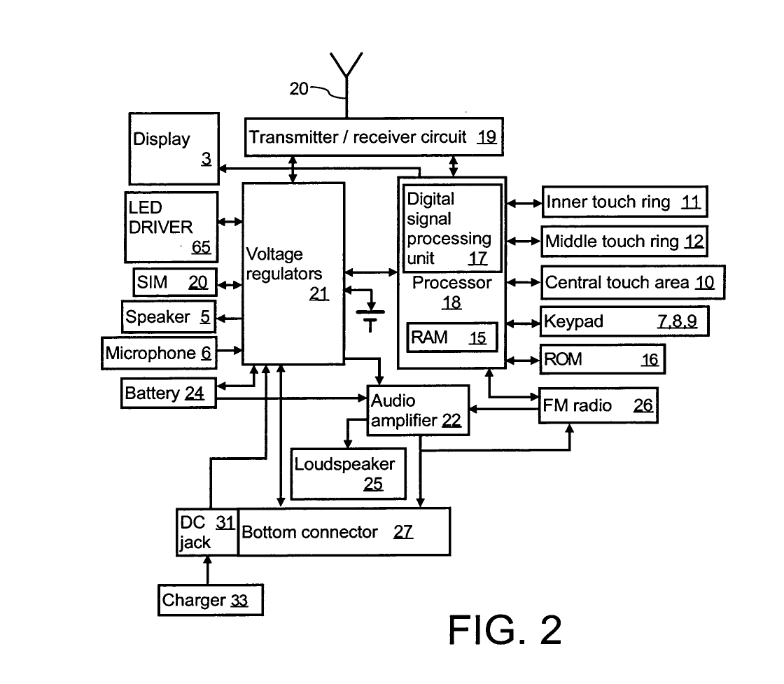

A releasable rear cover (not shown) gives access to the SIM card 20 (FIG. 2), and the battery pack 24 (FIG. 2) in the back of the phone that supplies electrical power for the electronic components of the mobile phone 1.

The mobile phone 1 has a flat display 3 that is typically made of an LCD with optional back lighting, such as a TFT matrix capable of displaying color images. A touch screen may be on top of the conventional LCD display.

FIG. 2 illustrates in block diagram form the general architecture of a mobile phone 1 constructed in accordance with the present invention. The processor 18 controls the operation of the terminal and has an integrated digital signal processor 17 and an integrated RAM 15. The processor 18 controls the communication with the cellular network via the transmitter/receiver circuit 19 and an internal antenna 20. A microphone 6 coupled to the processor 18 via voltage regulators 21 transforms the user's speech into analogue signals, the analogue signals formed thereby are A/D converted in an A/D converter (not shown) before the speech is encoded in the DSP 17 that is included in the processor 18. The encoded speech signal is transferred to the processor 18, which e.g. supports the GSM terminal software. The digital signal-processing unit 17 speech-decodes the signal, which is transferred from the processor 18 to the speaker 5 via a D/A converter (not shown).

The voltage regulators 21 form the interface for the speaker 5, the microphone 6, the LED drivers 65 (for the LEDS backlighting the keypad 7 and the display 3, and in some embodiments below the touchpad), the SIM card 20, battery 24, the bottom connector 27, the DC jack 31 (for connecting to the charger 33) and the audio amplifier 33 that drives the (hands-free) loudspeaker 25.

The processor 18 also forms the interface for some of the peripheral units of the device, including a Flash ROM memory 16, the graphical display 3, the keypad 7, the central select touch area 10, the inner touch ring 11, the outer touch ring 12, and an FM radio 26.

The touch rings 11,12 and the central touch area 10 are configured to provide one more control functions for controlling various applications associated with the mobile phone or other type of mobile electric device. For example, the touch initiated control function may be used to move an object or perform an action on the display 3 or to make selections or issue commands associated with operating the mobile phone or other mobile electric device. Normally, the touchpad is arranged to receive input from a finger moving over to the surface of the touchpad in order to implement the touch initiated control function. The touchpad receives input from a rotary or swirling finger motion over the inner touch ring 11 and/or the outer touch ring 12. By way of example, tapping a finger on the touch surface may initiate a control function, similar to the select function of central select area 10.

In one embodiment, the control function corresponds to a scrolling feature. For example, in case of a mobile phone the moving finger may initiate a control function for scrolling through a list of phone book entries displayed on the display 3. The term “scrolling” as used herein generally pertains to moving displayed data or images (e.g., text or graphics) across a display area of the display 3 and out of sight on one side of the display area as new content is added on the opposite side of the display area. The array of data may be treated as an endless loop, so that it is possible to continue scrolling when the end of the data has been reached.

The viewing area may be the entire viewing area of the display 3 or it may be only a portion of the display 3 (e.g. a window frame).

The direction of scrolling may be widely varied. For example, scrolling may be implemented vertically (as up or down) or horizontally (as left or right). In the case of vertical scrolling, when the user scrolls down, each set of new data appears at the bottom of the viewing area and all other sets of data move up one position. If the viewing area is full, the top set of data moves out of the viewing area. In one implementation the scrolling feature may be used to move graphical user interface vertically or horizontally in order to bring more data into view on the display 3. By way of example, the scrolling feature may be used to help browse through files stored in the electronic device, through images displayed on the display of the electronic device, a few songs stored in the electronic device or through phonebook entries stored in the device. The direction that the finger moves may be arranged to control the direction of scrolling. For example, the touchpad may be arranged to move the graphical user interface vertically up when the finger is moved anticlockwise and vertically down when the finger is moved clockwise.

In one embodiment two concentric rings are arranged so that an inner ring 11 provides scrolling through a first list and an outer ring 12 provides scrolling through a second list. The first and second list may be displayed on the display 3 at the same time or the action of moving a finger from one touch sensitive ring to another touch sensitive ring retrieves an earlier presented list or highlights a list already present on the display. The list may comprise images, contacts list, video clips, messages or other multimedia files.

The touch sensitive areas 10, 11, 12 together form a touchpad that generally consists of a touchable outer surface for receiving a finger for manipulation on the touchpad. Although not shown in FIGS. 1, 1A and 2, beneath the touchable outer surface is a sensor arrangement. The touchpad includes a plurality of sensors that are configured to be activated as the finger passes over them. In the simplest case, an electrical signal is produced each time the finger passes a sensor. The number of signals in a given timeframe may indicate the location, direction, speed and acceleration of the finger on the touchpad, i.e., the more signals, the more the user has moved his or her finger. In most cases, the signals are monitored by an electronic interface that converts the number, combination and frequency of the signals into location, direction, speed and exploration information. This information may then be used by the electronic device 1 to perform the desired control function, for example on the display 3.

The position of the touch sensitive areas 10, 11, 12 relative to the housing 2 may be widely varied. For example, the touchpad may be placed on any external surface (e.g. top, side, front or back) of the housing 2 that is accessible to the user during manipulation of the electronic device 1. In most cases the touch sensitive surface of the touchpad is completely exposed to the user. In the illustrated embodiments, the touch sensitive surface of the touchpad is on purposely not flush with the external surface of the housing 2.

The shape of the touch sensitive areas 10, 11, 12 may also be widely varied. For example, the touch sensitive areas may be circular, rectangular, triangular, and the like. In general, the outer perimeter of the shaped touchpad defines the working boundary of the touchpad. In the illustrated embodiment, the touchpad is oval. Oval touchpads allow a user to continue to swirl a finger in a free manner, i.e. the finger can be rotated to 360° of rotation without stopping. Furthermore, the user can rotate his or her finger eventually from all sides thus giving it more range of finger positions. More particular, the touchpad is annular, i.e. shaped like or formed as a ring. When annular, the inner and outer parameter of the shaped touchpad define the working boundary of the touchpad. Within these boundaries, the touchpad comprises according to an embodiment the inner touch ring 11 and the outer touch ring 12. The tensions of the various do not need to be closed curves, they can be open curves.

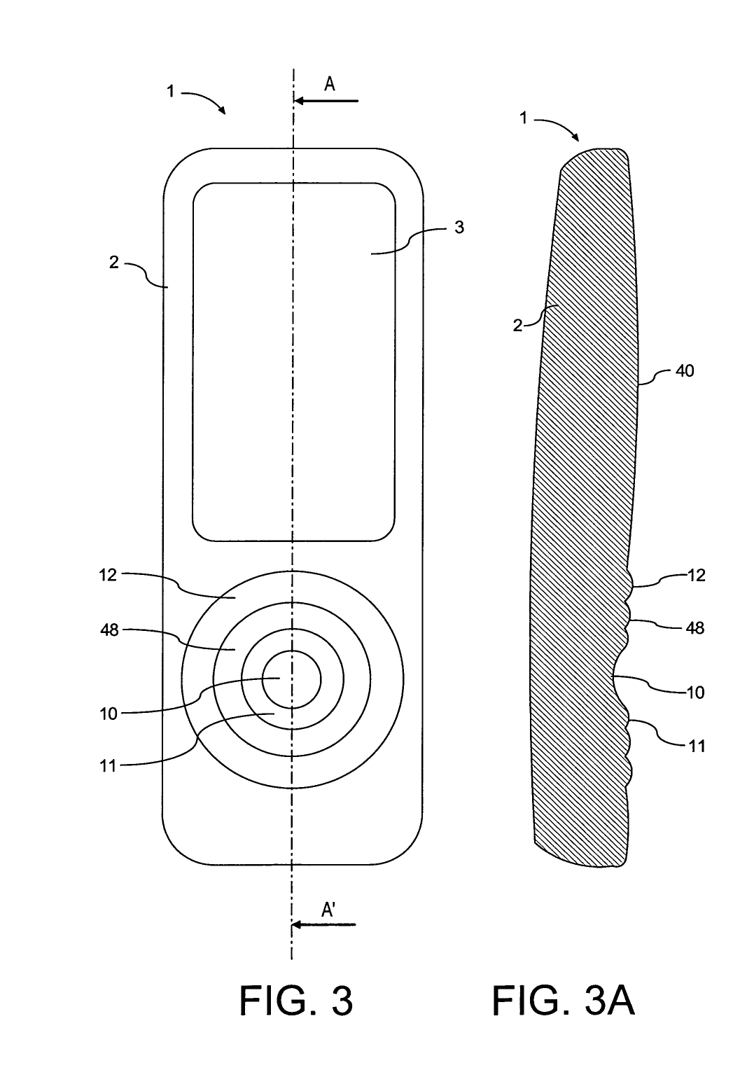

FIGS. 3 and 3A show another embodiment of the invention, that is essentially identical with the embodiment of FIG. 1, but in this embodiment the touch sensor includes three substantially concentric touch rings: an inner touch ring 11, a middle touch ring 48 and an outer touch ring 12. Further, mobile phone 1 according to this embodiment is not provided with a keypad and essentially all non-vocal user input is performed via the touch sensitive areas 10, 11, 12 and 48.

From the cross-sectional view in FIG. 3A and can be seen that the inner ring 11 middle ring 48 and the outer ring 12 are curving outward and the central circular touch area 10 is curving inward and thereby the curved touchpad areas are distinguished from one another and from the operating face 40 by level variations they form a series of peaks and a through.

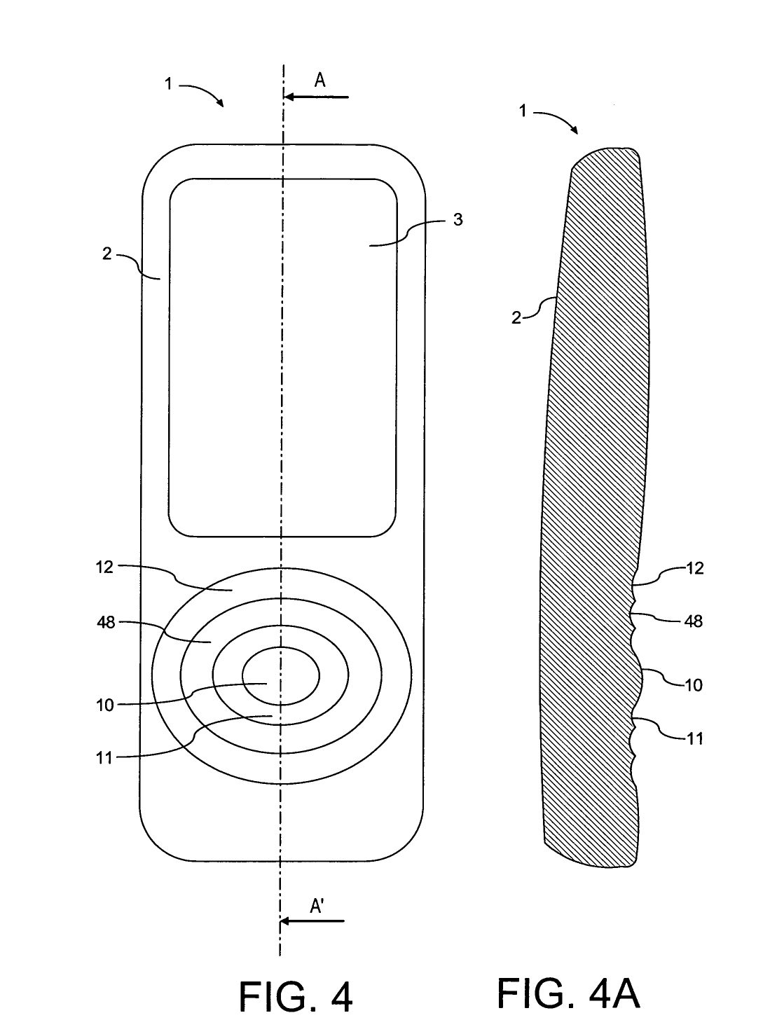

FIGS. 4 and 4A show another embodiment of the invention, that is essentially identical with the embodiment of FIG. 3, except that the touch sensitive areas 10, 11, 12, 48 are not circular but oval or elliptical. In this embodiment the inner ring 11, the middle ring 48 and the outer ring 12 are inwardly curving whilst the central oval touch area 10 is outwardly curving.

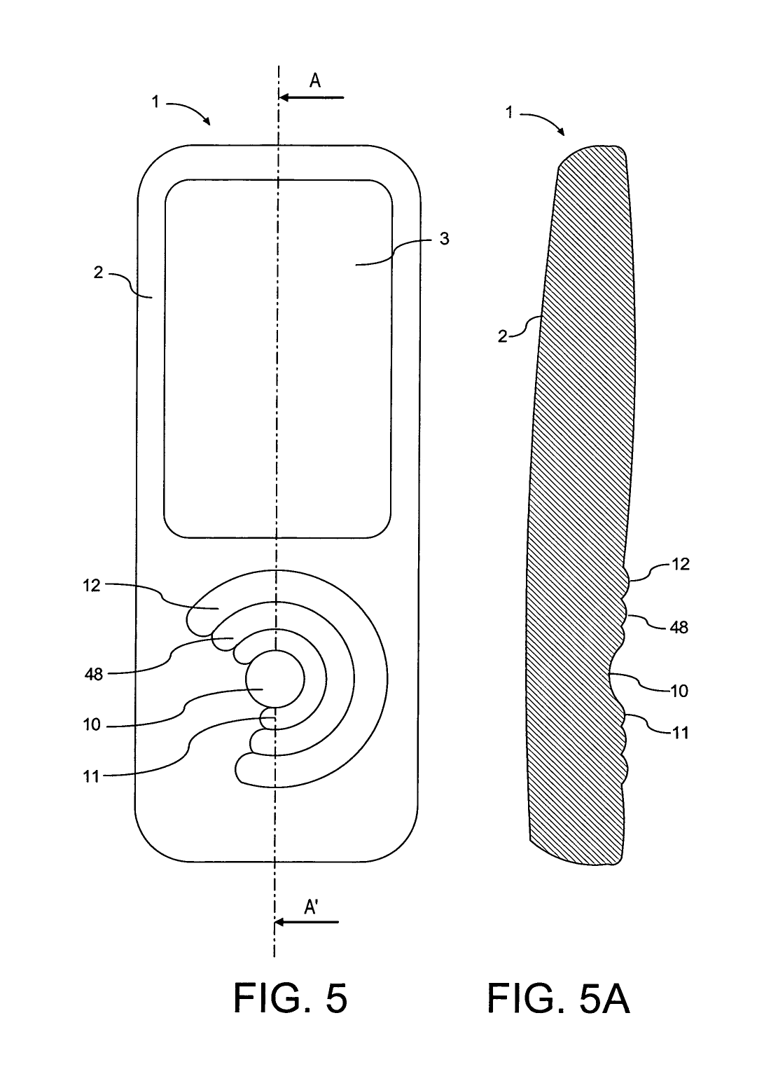

FIGS. 5 and 5A show another embodiment of the invention, that is essentially identical with the embodiment of FIG. 3, except that the touch sensitive areas 11, 12, 48 are closed curves but open curves.

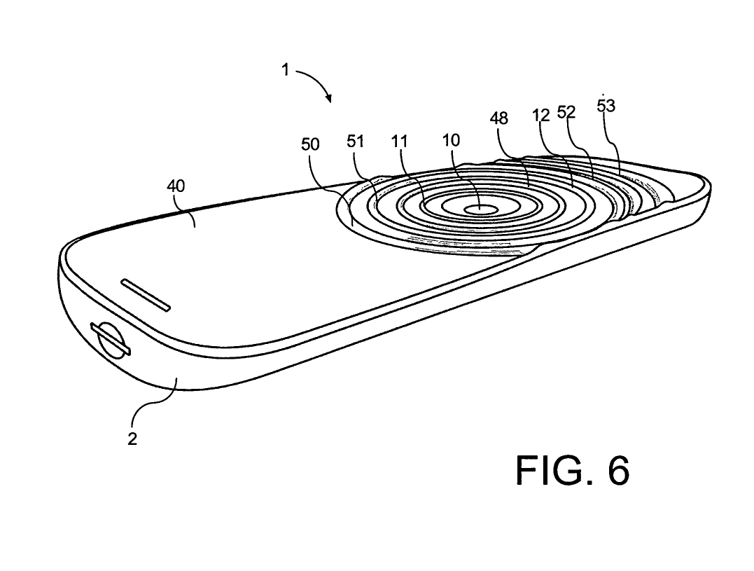

FIG. 6 is an elevated view of a variation of the device shown in FIGS. 5 and 5A. The portable device according to this embodiment has a seamless, flush or unitary surface (operating face) including the display and a concentric ring input area. The display is in this embodiment touch sensitive. This arrangement is advantageous in that the single surface of the operating face provides a seamless touch area so that a user may use the concentric ring user interface and then slide/swipe their finger to the display/touchpad area hence providing one continuous user interface area.

The embodiment of FIG. 6 is also provided with additional curved touch sensitive areas 50,51, 52 and 53, but can be used for various input functions.

It is helpful for a user to identify the individual touch sensitive areas when the curved touch sensitive areas 10,11,12,48 and/or their borders are raised and/or lowered relative to the operating face 40 and/or relative to neighboring curved touch sensitive areas.

Preferably, neighboring curved touch sensitive areas form a rippled or undulating surface. The curved touch sensitive areas can in an embodiment form a series of peaks and/or troughs that follow the curves of the curved touch sensitive areas.

In the curved touch sensitive areas should preferably be formed so that they can be felt (haptic feedback) by a user. This can be obtained by creating an undulating or rippled touchpad surface. Preferably in these ripples form concentric rings or concentric curved touch sensitive areas. A touch sensing device is arranged behind the ripples. The touch sensing device may be formed by one continuous touch sensitive area that is artificially divided into separate touch sensitive areas that correspond to curved sections defined by the ripples or undulations or other form of level changes of the surface above the continuous touch sensitive area. Various functions may be visible through the concentric rings or curved sections. These functions can be selected and then the input value off the function could be varied by sweeping the finger over the ring or curved section in a clockwise or anti-clockwise manner.

Thus, curved touch sensitive areas are configured so that the user can identify the curved touch sensitive areas on the operating device blindly, i.e. without looking.

The curved touch sensitive areas can be used for navigational input.

The central oval or circular touch sensitive area 10 can be used for selection input. Finger movement over a curved touch sensitive that is translated into a linear input for the electronic device. The finger movement can control a scrolling function.

The various aspects of the invention described above can be used alone or in various combinations. The invention is preferably implemented by a combination of hardware and software, but can also be implemented in hardware or software. Furthermore, although a scrolling feature is described, it should be noted that a scrolling feature is not the limitation and that the touchpad may be used to manipulate other features. For example, the touchpad may be used to adjust the volume control in an audio application. In addition, the touchpad may be used to advance to frames in a movie editing application. The touchpad may also be used in video game applications.

The invention has numerous advantages. Different embodiments or implementations may yield one or more of the following advantages. It should be noted that this is not an exhaustive list and there may be other advantages which are not described herein. One advantage of the invention is that a user is able to blindly identify the individual touch sensitive areas. It is another advantage of the invention that the user gains confidence in identifying and the various touch sensitive areas. It is yet another advantage of the invention that it provides tactile feedback concerning the location of touch sensitive areas. It is another advantage of the invention that it allows the operating face to be very attractively designed.

The touch sensing technology that is used for the touch but according to the present invention may capacitive, resistive, surface acoustic wave or any other known suitable technique.

Although the present invention has been described in detail for purpose of illustration, it is understood that such detail is solely for that purpose, and variations can be made therein by those skilled in the art without departing from the scope of the invention.

For example, although the invention has been described in terms of a hand portable device such as a mobile phone, it should be appreciated that the invention may also be applied to other types of electronic devices, such as still or motion cameras, video recorders, media players, palmtop computers, navigation device and the like. Moreover, certain aspects of the invention are not limited to handheld or hand portable devices. For example, the touchpad may also be used in other computing devices such as a laptop computer. The touchpad may also be used as a stand-alone input device that connects to a desktop or portable computer. It should also be noted that there are many alternative ways of implementing the methods and apparatuses of the present invention. For example, although the touchpad has been described in terms of being actuated by a finger, it should be noted that other objects may be used to actuate in some cases. For example, a stylus or other object may be used in some configurations of the touchpad.

The term “comprising” as used in the claims does not exclude other elements or steps. The term “a” or “an” as used in the claims does not exclude a plurality. The single processor or other unit may fulfill the functions of several means recited in the claims.

1-20. (canceled)

21. An electronic device comprising an input device including an operating face with two or more concentrically arranged curved touch sensitive areas, wherein said curved touch sensitive areas are distinguished from one another and from the operating face by level variations.

22. An electronic device according to claim 21, wherein said curved touch sensitive areas and/or their borders are raised and/or lowered relative to the operating face and/or relative to neighboring curved touch sensitive areas.

23. An electronic device according to claim 21, wherein neighbouring curved touch sensitive areas form a rippled or undulating surface.

24. An electronic device according to claim 21, wherein one of the concentrically arranged touch sensitive areas is a central oval or circular touch sensitive area.

25. An electronic device according to claim 21, wherein said curved touch sensitive areas form a series of peaks and/or troughs.

26. An electronic device according to claim 21, wherein said curved touch sensitive areas have the shape of closed curves.

27. An electronic device according to claim 26, wherein said closed curves are ovals or circles.

28. An electronic device according to claim 21, said device being hand portable.

29. An electronic device according to claim 28, comprising a mobile phone and/or a media player and/or a digital still or motion camera and/or a navigation device.

30. An electronic device according to claim 21, wherein said curved touch sensitive areas can be felt by a user.

31. An electronic device according to claim 21, wherein said curved touch sensitive areas are configured so that the user can identify the curved touch sensitive areas on the operating device without looking.

32. An electronic device according to claim 21, wherein at least one of said curved touch sensitive areas is used for navigational input.

33. An electronic device according to claim 24, wherein said central oval or circular touch sensitive area is used for selection input.

34. An electronic device according to claim 21, wherein finger movement over a curved touch sensitive area is translated into a linear input for the electronic device.

35. An electronic apparatus according to claim 34, wherein said in the finger movement controls a scrolling function.

36. An electronic apparatus according to claim 21, wherein said curved touch sensitive areas are distinct by level differentiation between the respective surfaces of the at least two or more curved touch sensitive areas.

37. A touchpad comprising two or more concentrically arranged curved touch sensitive areas, wherein the curved touch sensitive areas are distinguished from one another by level variations.

38. An electronic apparatus comprising an operating face with a display and a touchpad comprising two or more concentrically arranged curved touch sensitive areas, wherein the curved touch sensitive areas are distinguished from one another by level variations and the display and the touchpad are substantially flush with the operating face.

39. An electronic apparatus according to claim 38, wherein the display is touch sensitive.

40. An electronic apparatus according to claim 38, wherein the operating face including the display and the touchpad is substantially seamless.
